(19) United States
(12) Patent Application Publication
(10) Pub. No.: US 2023/0162391 A1
(43) Pub. Date: May 25, 2023

(54) METHOD FOR ESTIMATING THREE-DIMENSIONAL HAND POSE AND AUGMENTATION SYSTEM

(71) Applicant: ELECTRONICS AND TELECOMMUNICATIONS RESEARCH INSTITUTE, Daejeon (KR)

(72) Inventors: Yongho LEE, Daejeon (KR); Jeung Chul PARK, Daejeon (KR); Wookho SON, Daejeon (KR); Beom Ryeol LEE, Daejeon (KR)

(21) Appl. No.: 17/861,794

(22) Filed: Jul. 11, 2022

(30) Foreign Application Priority Data
Nov. 19, 2021 (KR) 10-20210160737

(51) Int. Cl. G06T 7/73; G06T 19/00; G06V 40/10

(52) U.S. Cl. CPC G06T 7/74; G06T 19/006; G06V 40/107

(57) ABSTRACT

A method for estimating a three-dimensional (3D) hand pose in an augmentation system is provided. The augmentation system receives a camera focal length and camera images from a device with a single RGB camera, outputs a 3D hand pose estimation result by performing hand bounding box detection and hand landmark detection from the camera images using one machine learning model, and augments the 3D hand pose estimation result on a display.

### CROSS-REFERENCE TO RELATED APPLICATION

This application claims priority to and the benefit of Korean Patent Application No. 10-2021-0160737 filed in the Korean Intellectual Property Office on Nov. 19, 2021, the entire contents of which are incorporated herein by reference.

### BACKGROUND OF THE INVENTION

### (a) Field of the Invention

The present disclosure relates to a method for estimating a three-dimensional (3D) hand pose and augmentation system, and more particularly, to a method for estimating a 3D hand pose and augmentation system capable of estimating the 3D hand pose of multiple users using only a single RGB camera and providing interaction with a 3D virtual object.

### (b) Description of the Related Art

Input/output devices such as video cameras, mobile terminals, and virtual reality (VR)/augmented reality (AR) headsets estimate a user's hand pose using camera images. The estimation result is expressed as a two-dimensional (2D) coordinate value (u, v) on an image and a relative depth value (d) based on a specific point.

If the purpose is to simply augment the hand pose on a 2D screen such as a monitor or a touch panel or to recognize a gesture, merely the 2D coordinate values (u, v) and the depth value (d) are sufficient. However, to interact with 3D virtual objects on interactive media or VR/AR contents, 3D coordinate values (x, y, z) including absolute depth values are required.

Conventional techniques implement interaction with a 3D virtual object by using depth camera information in addition to an RGB camera or a depth value based on a parallax map using a stereo camera for hand pose estimation. These conventional techniques increase the volume of the device and increase the cost due to an algorithm requiring a large number of cameras and high-level computing power.

In recent years, the demand for developing mobile application processor (AP)-based VR/AR headsets and interactive content devices that satisfy both cost reduction and miniaturization by adopting a minimum number of cameras is increasing.

Recently, studies on estimating a 3D hand pose using only a single RBG camera have been conducted in a PC environment, but there are two major problems in extending this to a mobile AP-based multi-user environment.

The first is that the speed is slow in mobile AP with weak computing power. In general, feature points are detected after detecting the hand boundary region, the amount of computation is large, and the computation speed increases linearly as the number of hands to be detected increases. Therefore, when the motions of multiple users need to be extracted at the same time, the speed problem is further highlighted.

Second, it is difficult to estimate the absolute depth value of the hand pose. A single RGB camera alone cannot distinguish exact depth values because of large objects that are far away and small objects that are close but are similarly sized in a 2D image. Therefore, the method of setting the wrist as the standard of depth (d=0) and estimating the remaining joints as relative depth values is generally used. However, since there is no absolute depth value of the hand pose, there is a problem in that accurate interaction is not possible in contents augmenting virtual objects based on real world coordinates.

### SUMMARY OF THE INVENTION

The present disclosure has been made in an effort to provide a method for estimating a three-dimensional (3D) hand pose and augmentation system capable of estimating the hand poses of multiple users using only a single RGB camera and providing accurate interaction with a 3D virtual object.

According to an embodiment of the present disclosure, a method for estimating a three-dimensional (3D) hand pose in an augmentation system is provided. The method for estimating a 3D hand pose includes: receiving a camera focal length and camera images from a device with a single RGB camera; outputting a 3D hand pose estimation result by performing hand bounding box detection and hand landmark detection from the camera images using one machine learning model; and augmenting the 3D hand pose estimation result on a display.

The outputting may include determining pixels of the hand region in the current frame by comparing the position of each pixel in the current frame with the position of the center pixel of a hand bounding box detected in the previous frame.

The determining may include: calculating a hand region expectation score for every pixel in the current frame; if each pixel of the current frame is a pixel adjacent to the center pixel of the hand bounding box detected in the previous frame, lowering a threshold value of the each pixel for classifying the hand region lower than a default value; if the each pixel of the current frame is not the adjacent pixel, setting the threshold to the default value; and determining a pixel having a hand region expectation score higher than a threshold value of the corresponding pixel as a pixel of the hand region.

The augmenting may include: converting coordinate values on the image and relative depth values corresponding to the 3D hand pose estimation result output from the machine learning model into 3D coordinate values of a camera coordinate system including absolute depth values; and converting the 3D coordinate values into coordinate values of a world coordinate system of the device.

The outputting may include adjusting the resolution of the camera images and then inputting it into the machine learning model.

The converting of the 3D coordinate values may include converting the relative depth value into an absolute depth value using the camera focal length, the resolution of the camera image, and the adjusted resolution.

The converting the relative depth values to the absolute depth values may include: recalculating the received camera focal length using the resolution of the camera image and the adjusted resolution; recalculating a vector from the wrist to a first joint of a middle finger calculated from the 3D hand pose estimation result using the adjusted resolution; and converting the relative depth values into the absolute depth values using the relative depth value, the recalculated camera focal length, and the recalculated vector.

The converting the 3D coordinate values into coordinate values of a world coordinate system of the device may include: obtaining a 3D vector value from the single RGB camera to the origin of the world coordinate system; and reflecting the 3D vector value to the 3D coordinate values.

An augmentation system that estimates a three-dimensional (3D) hand pose from an image and augments it on a display is provided. The augmentation system includes: a camera information inputter that receives a camera focal length and camera images from a device with a single RGB camera; and a hand pose estimator that estimates a 3D hand pose by performing hand bounding box detection and hand landmark detection from the camera images using a single machine learning model.

The machine learning model may calculate hand region expectation scores for all pixels in the current frame, and may determine a threshold value of each pixel for classifying the hand region by comparing a position of each pixel in the current frame with a position of the center pixel of a hand bounding box detected in the previous frame, and may determine a pixel having a higher hand region expectation score than the threshold value of the corresponding pixel as a pixel of the hand region.

The machine learning model, if each pixel of the current frame is a pixel adjacent to the center pixel of the hand bounding box detected in the previous frame, may set the threshold value of the pixel to a lower value than a default value, and if each pixel of the current frame is not a pixel adjacent to the center pixel, may set the threshold value of the pixel to the default value.

The augmentation system may further include: a depth value corrector that converts coordinate values on the image and relative depth values corresponding to the 3D hand pose estimation result output from the machine learning model into 3D coordinate values of a camera coordinate system including absolute depth values; and an augmentation processor that converts the 3D coordinate values of the camera coordinate system into coordinate values of the world coordinate system of the device and augments it on the display.

The camera information inputter may adjust a resolution of the camera image.

The depth value corrector may convert the relative depth values into the absolute depth values using the camera focal length, the resolution of the camera image, and the adjusted resolution.

The depth value corrector may recalculate the camera focal length using the resolution of the camera images and the adjusted resolution, may calculate a vector from the wrist to the first joint of the middle finger, recalculates a vector from the wrist to a first joint of a middle finger calculated from the 3D hand pose estimation result using the adjusted resolution, and may convert the relative depth values into the absolute depth values using the relative depth value, the recalculated camera focal length, and the recalculated vector.

The augmentation processor may reflect a 3D vector value from the single RGB camera to the origin of the world coordinate system to the 3D coordinate values of the camera coordinate system.

### BRIEF DESCRIPTION OF THE DRAWINGS

FIG. 1 is a diagram illustrating a configuration of an augmentation system according to an embodiment.

FIG. 2 is a flowchart illustrating an operation process of the camera information inputter illustrated in FIG. 1.

FIG. 3 is a diagram schematically illustrating the structure of the hand pose estimator shown in FIG. 1.

FIG. 4 is a flowchart illustrating a method for detecting a hand bounding box of the hand pose estimator shown in FIG. 1.

FIG. 5 is a flowchart illustrating an operation process of the depth value corrector shown in FIG. 1.

FIG. 6 is a diagram for explaining the concept of the augmentation processor shown in FIG. 1.

FIG. 7 is a diagram illustrating an augmentation system according to another embodiment.

### DETAILED DESCRIPTION OF THE EMBODIMENTS

Hereinafter, embodiments of the disclosure will be described in detail with reference to the attached drawings so that a person of ordinary skill in the art may easily implement the disclosure. As those skilled in the art would realize, the described embodiments may be modified in various different ways, all without departing from the spirit or scope of the disclosure. Accordingly, the drawings and description are to be regarded as illustrative in nature and not restrictive. Like reference numerals designate like elements throughout the specification.

Throughout the specification and claims, when a part is referred to “include” a certain element, it means that it may further include other elements rather than exclude other elements, unless specifically indicated otherwise.

Now, a method for estimating a three-dimensional (3D) hand pose and augmentation system will be described in detail with reference to the drawings.

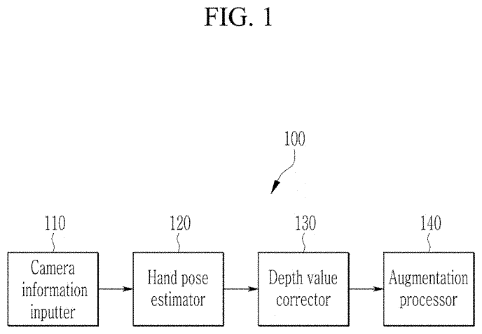

FIG. 1 is a diagram illustrating a configuration of an augmentation system according to an embodiment.

Referring to FIG. 1, the augmentation system includes a camera information inputter 110, a hand pose estimator 120, a depth value corrector 130, and an augmentation processor 140. The augmentation system may be a mobile AP based system.

The camera information inputter 110 receives camera information from a device having a single RGB camera, such as a video camera, a mobile terminal, and a VR/AR headset. The camera information may include a camera focal length and camera images. The camera information inputter 110 adjusts the camera images to an arbitrary resolution for machine learning and transmits it to an input of the machine learning model.

The hand pose estimator 120 performs hand type classification, hand bounding box detection, and hand landmark regression from the camera images received from the camera information inputter 110 at the same time. The hand pose estimator 120 estimates the 3D pose of each hand joint by using a machine learning model that simultaneously infers three loss values of hand type classification, hand bounding box detection, and hand landmark regression. This model structure makes it possible to maintain a constant detection speed even in a multi-user environment where multiple hand poses need to be extracted at the same time. The estimated result value for each hand is expressed as the (u, v, d) coordinate value of the camera coordinate system, where (u, v) is the normal coordinate system value on the 2D image, and d a relative depth value with respect to the wrist.

The hand pose estimator 120 performs a comparison with the previous frame in the hand bounding box detection process for temporal consistency of the estimation result, thereby makes it possible to accurately detect the hand bounding box even in difficult hand poses and afterimages caused by overlapping hand movements between multiple users.

The depth value corrector 130 calculates coordinate values (X, Y, Z) of the 3D coordinate system of the hand pose, based on the estimated coordinate values (u, v, d) of the hand pose output from the hand pose estimator 120. The depth value corrector 130 may convert the coordinate values (u, v, d) of the camera coordinate system into coordinate values (X, Y, Z) of the 3D coordinate system by using a transformation matrix. Here, Z is an absolute depth value, and since d is a relative value with respect to the image plane, it is not expressed as an absolute depth value. Accordingly, the depth value corrector 130 calculates the absolute depth value from the relative depth value (d), by using the camera focal length received through the camera information inputter 110, the resolution of the original input image, and the resolution adjusted through the camera information inputter 110.

The augmentation processor 140 converts the coordinate values (X, Y, Z) of the hand pose output by the depth value corrector 130 into coordinate values of the world coordinate system of the device and augments them on the display. The coordinate values (X, Y, Z) of the hand pose output by the depth value corrector 130 can be referred to as local coordinate values with the position of a single RGB camera as the origin, based on the world coordinate system of the device. The augmentation processor 140 may convert the coordinate values (X, Y, Z) of the hand pose output by the depth value corrector 130 into coordinate values of the world coordinate system of the device, by reflecting a 3D vector value to the coordinate values (X, Y, Z) of the hand pose output by the depth value corrector 130. The 3D vector value corresponds to the difference between the origin position of a single RGB camera and the origin position of the world coordinate system.

Since the camera image of the single RGB camera is processed by the camera information inputter 110, the hand pose estimator 120, the depth value corrector 130, and the augmentation processor 140, the user can check the augmented 3D hand pose estimation value using only the single RGB camera, and it provides an accurate interaction experience with a 3D virtual object.

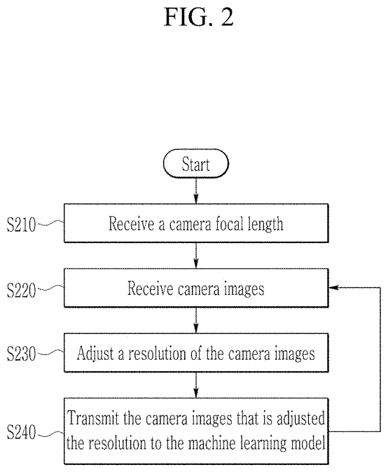

FIG. 2 is a flowchart illustrating an operation process of the camera information inputter illustrated in FIG. 1.

Referring to FIG. 2, the camera information inputter 110 receives a camera focal length value from a device equipped with a single RGB camera and stores it in a memory (S210).

The camera information inputter 110 receives camera images from a single RGB camera (S220), and adjusts a resolution of the received camera images to an arbitrary resolution for machine learning (S230).

Next, the camera information inputter 110 transmits the resolution-adjusted camera image to the machine learning model (S240).

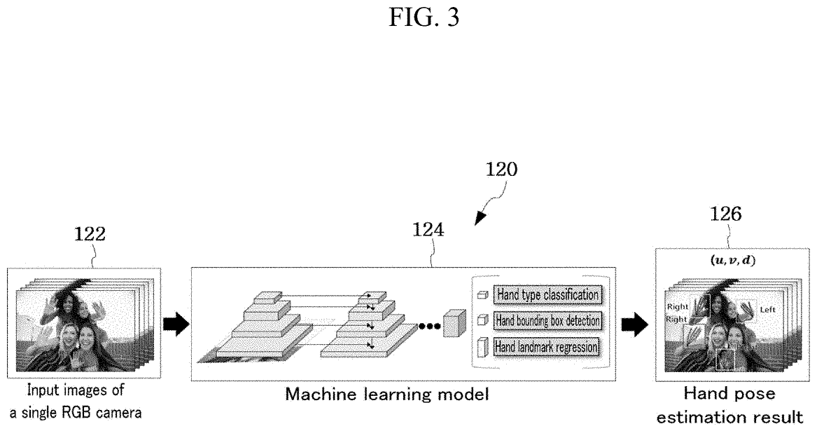

FIG. 3 is a diagram schematically illustrating the structure of the hand pose estimator shown in FIG. 1.

Referring to FIG. 3, the hand pose estimator 120 includes an inputter 122, a machine learning model 124, and an outputter 126.

The inputter 122 inputs the camera images received through the camera information inputter 110 to the machine learning model 124.

The machine learning model 124 performs hand type classification, hand bounding box detection, and hand landmark regression from the input camera images. The machine learning model 124 classifies hand type indicating whether it is a left hand or a right hand while detecting a hand bounding box, detects hand landmarks from the hand bounding box, and outputs the detection result as a hand pose estimation result.

The outputter 126 outputs the hand pose estimation result output from the machine learning model 124 to the depth value corrector 130. The hand pose estimation result may include a hand type indicating whether the hand is a left hand or a right hand, a detected hand bounding box, and coordinate values (u, v, d) of hand landmarks.

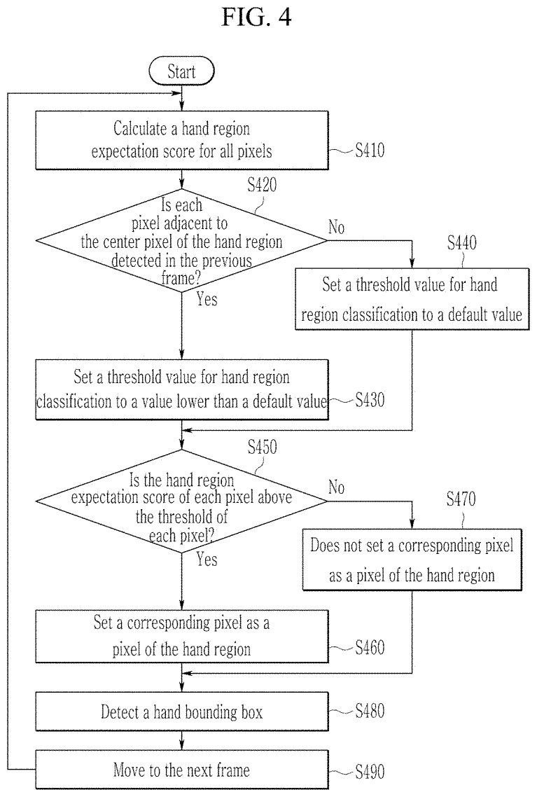

FIG. 4 is a flowchart illustrating a method for detecting a hand bounding box of the hand pose estimator shown in FIG. 1.

Referring to FIG. 4, the machine learning model 122 calculates a hand region expectation score for all pixels of the frame (S410). The hand region expectation score may be expressed as a decimal point from 0 to 1, for example.

The machine learning model 122 sets a window of a predetermined size, and checks whether each pixel within the window is a pixel adjacent to the center pixel of the hand region detected in the previous frame (S420). In this way, for every pixel in the frame, the machine learning model 122 checks whether the pixel is adjacent to the center pixel of the hand region detected in the previous frame.

If the corresponding pixel is a pixel adjacent to the center pixel of the hand region detected in the previous frame, the machine learning model 122 sets a threshold value for hand region classification to a lower value than the default value (S430), and if it is not an adjacent pixel, sets the threshold value as a default value (S440).

Thereafter, the machine learning model 122 compares a threshold value set individually for each pixel with the hand region expectation score of each pixel (S450).

The machine learning model 122 sets only pixels having a higher hand region expectation score than the threshold value set individually for each pixel as a pixel of the hand region (S460), and then finally detects a hand bounding box based on the hand region pixels (S480).

Since the position of the hand between consecutive frames does not change rapidly, in the embodiment of the present disclosure, the threshold value is lowered for the hand region where the hand existed in the previous frame so that the hand region tracking can be continuously performed without interruption. As a result, it enables hand bounding box detection to be performed well even in difficult hand poses and the afterimage caused by overlapping hand movements between multiple users.

Meanwhile, the machine learning model 122 does not set the corresponding pixel as a pixel of the hand region when the hand region expectation score of the corresponding pixel is lower than the threshold value of the corresponding pixel (S470).

In this way, when the hand bounding box is detected in the frame, the center pixel position of the hand region is determined. The center pixel of the hand region is used when performing step S420 in the next frame.

Thereafter, the machine learning model 122 moves to the next frame (S490) and repeats steps S410 to S480.

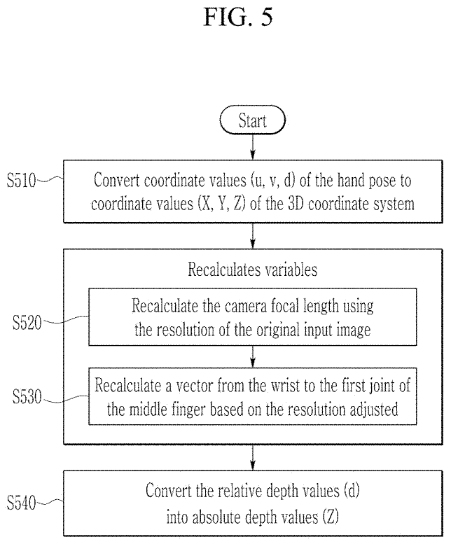

FIG. 5 is a flowchart illustrating an operation process of the depth value corrector shown in FIG. 1.

Referring to FIG. 5, the depth value corrector 130 converts the coordinate values (u,v,d) of the hand pose extracted through the hand pose estimator 120 using the transformation matrix to the coordinate values (X, Y, Z) of the 3D coordinate system (S510). As described above, since the depth value (d) is a relative value with respect to the image plane, it is not expressed as an absolute depth value. That is, in step S510, the coordinate values (X, Y) may be calculated from the coordinate values (u,v) of the hand pose.

Next, the depth value corrector 130 recalculates the variables to calculate the absolute depth value (Z).

Specifically, the depth value corrector 130 recalculates the camera focal length received from the camera information inputter 110 using the resolution of the original input image and the resolution adjusted by the camera information inputter 110 (S520).

The depth value corrector 130 recalculates the vector from the wrist to the first joint of the middle finger based on the resolution adjusted by the camera information inputter 110 (S530).

When the camera focal length received through the camera information inputter 110 is fx, fy (fx=xy), the size of the resolution of the original input image is W×H, the size of the resolution adjusted through the camera information inputter 110 is R×R, the length from the wrist to the first joint of the middle finger is v, and the vector from the wrist to the first joint of the middle finger calculated from the coordinate values (u, v, d) of the hand pose extracted through the hand pose estimator 120 is (x, y, z), the depth value corrector 130 recalculates fx, fy, and (x, y, z) as in Equation 1.

fₓ=fₓ÷W×R

f_{y}=f_{y}÷H×R

x=x×R

y=y×R

z=Z×R (Equation 1)

Next, the depth value corrector 130 may convert the relative depth value (d) into an absolute depth value (Z) by using the recalculated camera focal length and the recalculated vector (x, y, z) from the wrist to the first joint of the middle finger based on Equation 1 (S540). The depth value corrector 130 may convert the depth value (d) into an absolute depth value (Z) as shown in Equation 2 by using the recalculated variables [fx, fy, (x, y, z)].

$$Z = d - R + \sqrt{( {v}^{2} - {z}^{2} ) \div ( {( \frac{x}{{f}_{x}} )}^{2} + {( \frac{y}{{f}_{y}} )}^{2} )} \qquad ( Equation 2 )$$

In this way, the coordinate values (u, v, d) of the hand pose extracted through the hand pose estimator 120 are converted into coordinate values (X, Y, Z) of the 3D coordinate system.

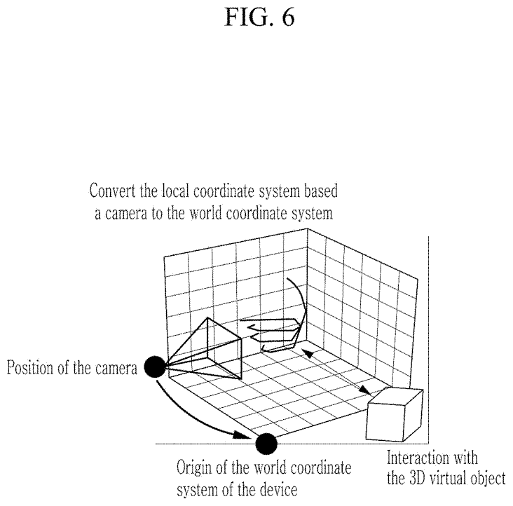

FIG. 6 is a diagram for explaining the concept of the augmentation processor shown in FIG. 1.

Referring to FIG. 6, based on the world coordinate system of the device, the coordinate values (X, Y, Z) of the 3D coordinate system of the hand pose output from the depth value corrector 130 can be said to be coordinate values of the local coordinate system with the position of a single RGB camera as the origin.

If a 3D vector value from a single RGB camera such as a VR/AR headset to the origin of the world coordinate system of the device is provided, the augmentation processor 140 adds the 3D vector value to a 3D coordinate values (X, Y, Z) of the hand pose output from the depth value corrector 130, and then augments it on the display.

In the case of an interactive content device based on an image camera or mobile terminal, the augmentation processor 140 calculates a 3D vector value from a single RGB camera to the origin of the world coordinate system set by the content creator, and adds the calculated 3D vector value to a 3D coordinate value (X, Y, Z) of the hand pose output from the depth value corrector 130, and then augments it on the display.

By going through the above process, the user can check the 3D hand pose estimation result augmented on the display from the images of the single RGB camera, and it can provide an accurate interaction experience with the 3D virtual object.

FIG. 6 is a diagram for explaining the concept of the augmentation processor shown in FIG. 1.

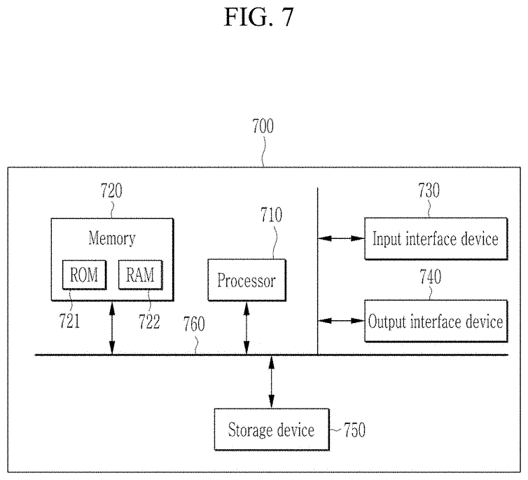

Referring to FIG. 7, the augmentation system 700 may represent a computing device in which the method for estimating a 3D hand pose described above is implemented.

The augmentation system 700 may include at least one of a processor 710, a memory 720, an input interface device 730, an output interface device 740, and a storage device 750. Each of the components may be connected by a common bus 760 to perform communication with each other. In addition, each of the components may be connected through an individual interface or a separate bus centering on the processor 710 instead of the common bus 760.

The processor 710 may be implemented as various types such as an application processor (AP), a central processing unit (CPU), a graphics processing unit (GPU), etc., and may be any semiconductor device that executes a command stored in the memory 720 or the storage device 750. The processor 710 may execute a program command stored in at least one of the memory 720 and the storage device 750. The processor 710 stores program instructions for implementing at least some functions of the camera information inputter 110, the hand pose estimator 120, the depth value corrector 130, and the augmentation processor 140 described with reference to FIG. 1 in the memory 720, and may control to perform the operation described with reference to FIGS. 1 to 6.

The memory 720 and the storage device 750 may include various types of volatile or non-volatile storage media. For example, the memory 720 may include a read-only memory (ROM) 721 and a random access memory (RAM) 722. The memory 720 may be located inside or outside the processor 710, and the memory 720 may be connected to the processor 710 through various known means.

The input interface device 730 is configured to provide data to the processor 710.

The output interface device 740 is configured to output data from the processor 710.

At least some of the method for estimating the 3D hand according to the embodiment may be implemented as a program or software executed in a computing device, and the program or software may be stored in a computer-readable medium.

In addition, at least some the method for estimating the 3D hand according to the embodiment may be implemented as hardware that may be electrically connected to the computing device.

According to an embodiment, by using a single RGB camera and one machine learning model, it is possible to estimate the hand poses of multiple users even in a mobile AP environment with weak computing power.

In addition, by correcting a relative depth value estimated from an image of a single RGB camera to an absolute depth value, augmentation to a device display and accurate interaction with a 3D virtual object can be supported.

The components described in the example embodiments may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the example embodiments may be implemented by software, and the software may be recorded on a recording medium. The components, functions, and processes described in the example embodiments may be implemented by a combination of hardware and software. The method according to embodiments may be embodied as a program that is executable by a computer, and may be implemented as various recording media such as a magnetic storage medium, an optical reading medium, and a digital storage medium. Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing, or to control an operation of a data processing apparatus, e.g., by a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network. Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic or magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., and magneto-optical media such as a floptical disk and a read only memory (ROM), a random access memory (RAM), a flash memory, an erasable programmable ROM (EPROM), and an electrically erasable programmable ROM (EEPROM), and any other known computer readable media. A processor and a memory may be supplemented by, or integrated into, a special purpose logic circuit. The processor may run an operating system (08) and one or more software applications that run on the OS. The processor device also may access, store, manipulate, process, and create data in response to execution of the software. For purpose of simplicity, the description of a processor device is used as singular; however, one skilled in the art will appreciate that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media. The present specification includes details of a number of specific implements, but it should be understood that the details do not limit any disclosure or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination. Similarly, even though operations are described in a specific order in the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products. It should be understood that the embodiments disclosed herein are merely illustrative and are not intended to limit the scope of the disclosure. It will be apparent to one of ordinary skill in the art that various modifications of the embodiments may be made without departing from the spirit and scope of the claims and their equivalents.

What is claimed is:

1. A method for estimating a three-dimensional (3D) hand pose in an augmentation system, the method comprising:
receiving a camera focal length and camera images from a device with a single RGB camera;
outputting a 3D hand pose estimation result by performing hand bounding box detection and hand landmark detection from the camera images using one machine learning model; and
augmenting the 3D hand pose estimation result on a display.

2. The method of claim 1, wherein the outputting includes determining pixels of the hand region in the current frame by comparing the position of each pixel in the current frame with the position of the center pixel of a hand bounding box detected in the previous frame.

3. The method of claim 2, wherein the determining includes:
calculating a hand region expectation score for every pixel in the current frame;
if each pixel of the current frame is a pixel adjacent to the center pixel of the hand bounding box detected in the previous frame, lowering a threshold value of the each pixel for classifying the hand region that is lower than a default value;
if the each pixel of the current frame is not the adjacent pixel, setting the threshold to the default value; and
determining a pixel having a higher hand region expectation score than a threshold value of the corresponding pixel as a pixel of the hand region.

4. The method of claim 1, wherein the augmenting includes:
converting coordinate values on the image and relative depth values corresponding to the 3D hand pose estimation result output from the machine learning model into 3D coordinate values of a camera coordinate system including absolute depth values; and
converting the 3D coordinate values into coordinate values of a world coordinate system of the device.

5. The method of claim 4, wherein the outputting includes adjusting the resolution of the camera images and then inputting it into the machine learning model.

6. The method of claim 5, wherein the converting of the 3D coordinate values includes converting the relative depth value into an absolute depth value using the camera focal length, the resolution of the camera image, and the adjusted resolution.

7. The method of claim 6, wherein the converting the relative depth values to the absolute depth values includes:
recalculating the received camera focal length using the resolution of the camera image and the adjusted resolution;
recalculating a vector from the wrist to a first joint of a middle finger calculated from the 3D hand pose estimation result using the adjusted resolution; and
converting the relative depth values into the absolute depth values using the relative depth value, the recalculated camera focal length, and the recalculated vector.

8. The method of claim 4, wherein the converting the 3D coordinate values into coordinate values of a world coordinate system of the device includes:
obtaining a 3D vector value from the single RGB camera to the origin of the world coordinate system; and
reflecting the 3D vector value to the 3D coordinate values.

9. An augmentation system that estimates a three-dimensional (3D) hand pose from an image and augments it on a display, the system comprising:
a camera information inputter that receives a camera focal length and camera images from a device with a single RGB camera; and
a hand pose estimator that estimates a 3D hand pose by performing hand bounding box detection and hand landmark detection from the camera images using a single machine learning model.

10. The system of claim 9, wherein the machine learning model calculates hand region expectation scores for all pixels in the current frame, and determines a threshold value of each pixel for classifying the hand region by comparing a position of each pixel in the current frame with a position of the center pixel of a hand bounding box detected in the previous frame, and determines a pixel having a higher hand region expectation score than the threshold value of the corresponding pixel as a pixel of the hand region.

11. The system of claim 10, wherein the machine learning model, if each pixel of the current frame is a pixel adjacent to the center pixel of the hand bounding box detected in the previous frame, sets the threshold value of the pixel to a lower value than a default value, and if each pixel of the current frame is not a pixel adjacent to the center pixel, sets the threshold value of the pixel to the default value.

12. The system of claim 9, further comprising:
a depth value corrector that converts coordinate values on the image and relative depth values corresponding to the 3D hand pose estimation result output from the machine learning model into 3D coordinate values of a camera coordinate system including absolute depth values; and
an augmentation processor that converts the 3D coordinate values of the camera coordinate system into coordinate values of the world coordinate system of the device and augments it on the display.

13. The system of claim 12, wherein the camera information inputter adjusts a resolution of the camera image.

14. The system of claim 13, wherein the depth value corrector converts the relative depth values into the absolute depth values using the camera focal length, the resolution of the camera image, and the adjusted resolution.

15. The system of claim 14, wherein the depth value corrector recalculates the camera focal length using the resolution of the camera images and the adjusted resolution, calculates a vector from the wrist to the first joint of the middle finger, recalculates a vector from the wrist to a first joint of a middle finger calculated from the 3D hand pose estimation result using the adjusted resolution, and converts the relative depth values into the absolute depth values using the relative depth value, the recalculated camera focal length, and the recalculated vector.

16. The system of claim 12, wherein the augmentation processor reflects a 3D vector value from the single RGB camera to the origin of the world coordinate system to the 3D coordinate values of the camera coordinate system.
